(19) United States
(12) Patent Application Publication
(10) Pub. No.: US 2023/0060285 A1
(43) Pub. Date: Mar. 2, 2023

(54) Micro-Grid Wind Power Generator

(71) Applicant: Anew Energy LLC, Glenwood Springs, CO (US)

(72) Inventors: Patrick Conarro, Glenwood Springs, CO (US); Tate Smith, Marietta, CO (US); Jacob Wolf, Prescott Valley, AZ (US)

(73) Assignee: Anew Energy LLC, Glenwood Springs, CO (US)

(21) Appl. No.: 17/822,796

(22) Filed: Aug. 28, 2022

Related U.S. Application Data
(60) Provisional application No. 63/238,207, filed on Aug. 29, 2021.

(51) Int. Cl. F03D 3/06; F03D 9/25; F03D 3/00

(52) U.S. Cl. CPC F03D 3/061; F03D 9/25; F03D 3/005; F03D 3/062; F05B 2240/213

(57) ABSTRACT

A wind turbine is optimized for low and high speed winds with sensing to measure climate change gases using IoT connectivity with long life serviceability. The wind turbine has an egg-shaped or elliptical profile that performs well in any physical orientation, enabling plural turbines in either horizontal or vertical stacks. A wildlife net is applied to the intake sides of the wind turbine, where the profile secures the net against displacement.

### BACKGROUND

Micro-grid wind power generation has never been more important. As the climate crisis unfolds, measures must be taken to ensure reliable energy is available while improving efficiencies for wind power. Micro-grid renewable energy power generation consists of bringing wind, water, solar and distribution together at the point of consumption. Residential and commercial applications tend not to include wind power since the equipment is obstructive to the site owner and wildlife. The design and construction of these wind turbines, which must withstand hurricane force winds, has never been properly addressed for small turbines. These turbines need to be easily serviced at the site once installed. Installations in urban sites are not cost effective where cranes and permits are needed to hoist equipment to the rooftops of large residential and commercial buildings.

Most of the world operates at low wind speeds. The wind industry has left energy on the table where wind speeds below 7 MPH do not have the forces needed to start turning commercial scale wind mills. Large scale wind farms are expensive to deploy and maintain and are harmful to local and migratory birds. The wind power industry has been emphasizing building large wind mills in high wind speed corridors rather than considering smaller wind mills that can be scaled while producing minimal site impact. Large wind turbines require transmissions lines, while smaller micro-grid turbines build and distribute power at the point of use. Small wind mills that can be transported via an elevator or stairways can be positioned on the roof and installed without substantial support equipment.

Lightweight, high strength wind turbines that protect wildlife and can easily be serviced do not exist, even though Vertical Axis Wind Turbines (VAWT) have been around for centuries. When this shape is designed for field service events, mass scale adoption has a higher chance of success. The environmental cleanup effort to rid the world of emissions that are creating climate change need to be monitored, measured, and responded to using global data acquisition equipment and sampling methods. The wind turbine is an excellent device to take those readings at scale.

### BRIEF SUMMARY OF THE INVENTION

According to the invention, a wind turbine has a roughly egg shaped configuration, producing a highly weather resistant, waterproof structure. Onboard ambient air quality monitoring instruments are integrated to work with the waterproof structure. A wildlife mesh is secured in place by the egg shaped configuration. Traditional problems in starting wind turbines are overcome by the use of small, brushless 3-Phase motors/generators that collectively have enormous energy potential with low starting forces required to start making power. An algorithm determines when these small motors/generators are selectively engaged. The generators require minimal force to overcome magnetic fields, until a critical number of the generators are coupled to work together. Then, the magnetic fields are synchronized for optimal performance.

### BRIEF DESCRIPTION OF THE DRAWINGS

FIG. 1 is a side elevation view of a wind turbine.

FIG. 2 is an exploded view of the wind turbine of FIG. 1.

FIG. 3 is a vertical cross-section take through the center of the wind turbine of FIG. 1.

FIG. 4 is a detail view taken from FIG. 3 near the upper end thereof.

FIG. 5 is detail view taken from FIG. 3 above the position of FIG. 4.

FIG. 6 is top plan view of the wind turbine of FIG. 1.

FIG. 7 is a detail view of FIG. 1 taken near the top thereof.

FIG. 8 is a bottom horizontal view taken from the bottom of FIG. 7.

FIG. 9 is an isometric view of a central assembly of the wind turbine of FIG. 1.

FIG. 10 is a top plan view of the wind turbine of FIG. 1 with the dome cover removed.

FIG. 11 is an isometric view of the dome of the wind turbine of FIG. 1 with exploded detail of generator drive covers.

FIG. 12 is a detailed isometric view of belt tensioning for spinning the brushless generators, taken from FIG. 11.

FIG. 13 is an upper side isometric view of a dual drive generator assembly.

FIG. 14 is a lower side isometric view of the dual drive generator assembly of FIG. 13.

FIG. 15 is a top plan view of a dual drive generator assembly of FIG. 13.

FIG. 16 is a side view of the dual drive generator assembly of FIG. 13.

FIG. 17 is vertical cross sectional view of the dual drive generator of FIG. 16.

FIG. 18 is a vertical cross sectional view two brushless generators, similar to FIG. 17.

FIG. 19 is an exploded view of a brushless dual drive generator assembly.

FIG. 20 is a side elevation view of a communications module.

FIG. 21 is a central vertical cross section of the module of FIG. 20.

FIG. 22 is a horizontal upward view of the bottom of the module of FIG. 20.

FIG. 23 is a horizontal plan view of the module of FIG. 20 with cover removed.

FIG. 24 is an exploded view of the module of FIG. 20.

FIG. 25 is an isometric view taken from bottom and side of a connector on a daughter board of the module of FIG. 20.

FIG. 26 is a side elevation view of a tubular wildlife mesh for placement over the wind turbine of FIG. 1 in vertical position, with a projection of the wildlife mesh into an installed position on the wind turbine of FIG. 1

FIG. 27 is a side elevation view of an unfurled wildlife mesh of FIG. 26 for placement over the wind turbine of FIG. 1 in horizontal position, with a projection of the wildlife mesh into an installed position on the wind turbine within an array of wind turbines.

FIG. 28 is a diagram of power management logic.

FIG. 29 is a graph of the power curve of a 3-phase generator.

FIG. 30 is a graph of the power curve of multiple generators.

FIG. 31 is an isometric view of a power control board.

FIG. 32 is a top plan view of the power control board of FIG. 31.

FIG. 33 is an isometric view of the power control board of FIG. 31.

FIG. 34 is a top plan view of the power control board of FIG. 31.

FIG. 35 is a schematic diagram of operation of a light bar.

FIG. 36 is a schematic diagram of turbines reporting operational data.

### DETAILED DESCRIPTION OF THE INVENTION

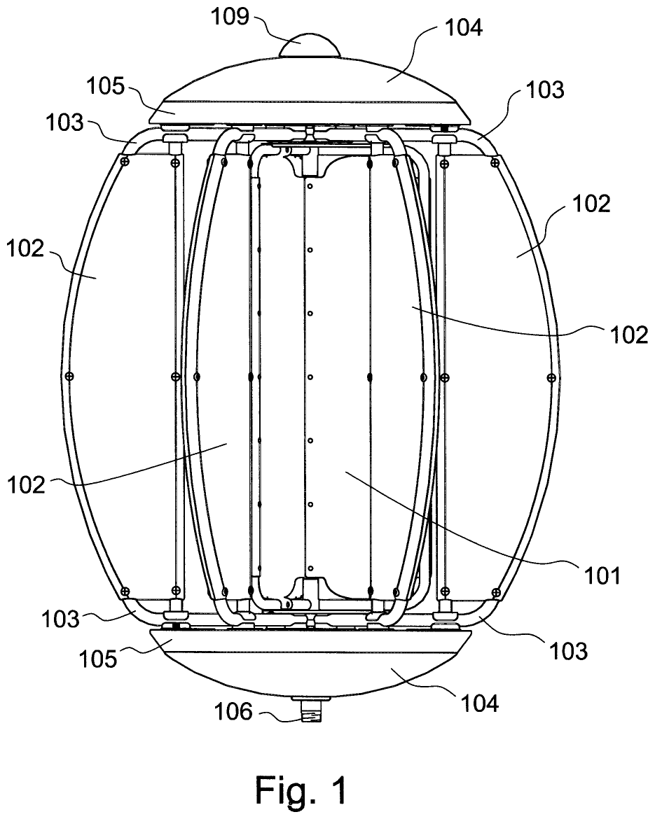

FIG. 1 is a vertical view of the invention that defines the elliptical or egg shape that is optimized for strength and low wind speeds. A rotor assembly 101 is formed of air foils and spins within the stater blade tubular frame wing assemblies 102. The outer edge of the array of wing assemblies is arcuate, with the tubular frame establishing the arc of each wing. Element 103 is the tubular super structure. Power generation assembly is within an upper end middle dome 104. A similar dome 104 is located at a lower end position. A light bar 105 around the upper end middle dome 104 signals with LED lighting, how much power is being generated and service events. A lower pipe tube 106 is used for mounting. Pipe tube 106 can also be mounted in the top to support various mounting requirements.

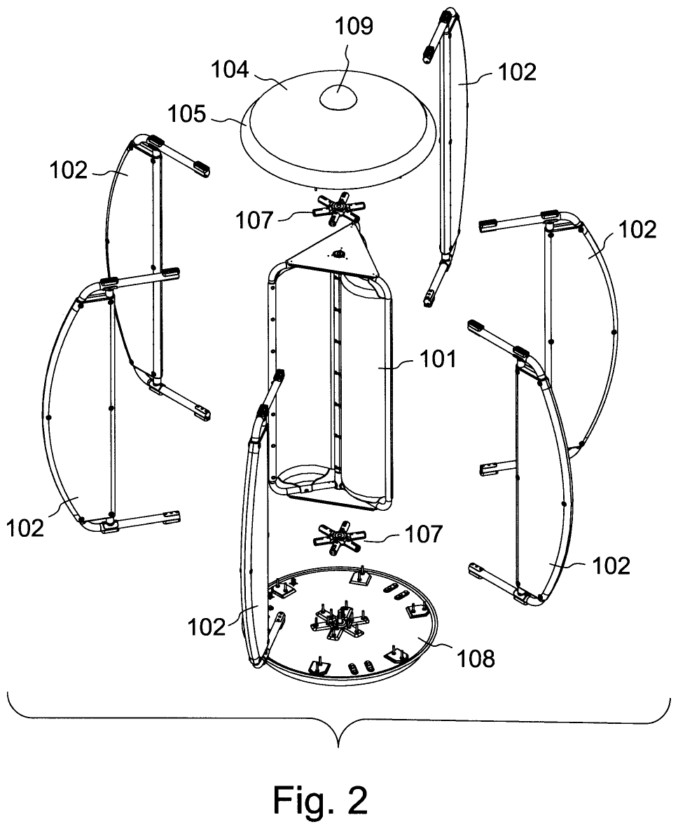

FIG. 2 is an exploded view of the sub assemblies used to build out the assembly. These sub assemblies are standard components that can easily be replaced in the field and at the installation. Each sub assembly can be handled and assembled by a single human. A star connector assembly 107 with shaft bearings brings together all sub assembly components 102,101, and 108. A dome generator drive interface 108 is located in both upper and lower end domes 104 and shows embossed features. These subcomponents are capable of being manually handled and assembled on building rooftops, which are desirable mounting locations for a wind turbine. Ease of handling eliminates the need for large cranes that require municipality permits and increase the overall cost of ownership.

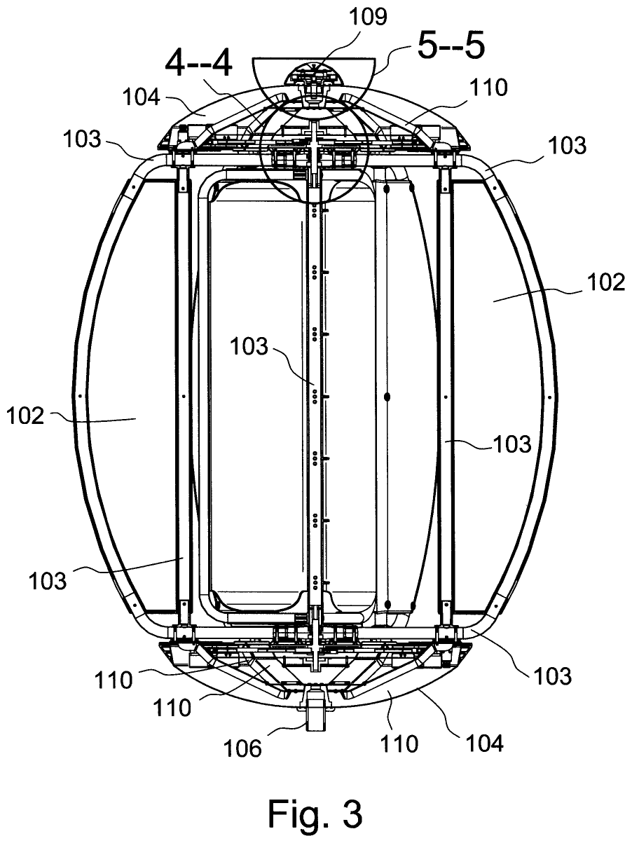

FIG. 3 is a lateral cross section through the center of the turbine. 106 shows the mounting pipe tube used to secure the equipment and pull DC power connectors out to the local grid. Wing assemblies 102 and stainless steel superstructure 103 form a stainless steel, tubular egg-shaped or elliptical outer wing amplifier. Upper end middle dome assembly 104 pushes air samples into a sensing and communications assembly 109 in a top dome. A middle dome super structure 110 builds strength within the dome assembly. As evident from the profiles shown in FIGS. 1-3, the top and bottom domes plus the arcuate outside edges of the wings form a profile that relative to the top and bottom ends has a broader middle portion and narrower upper and lower portions at least at the array of wings

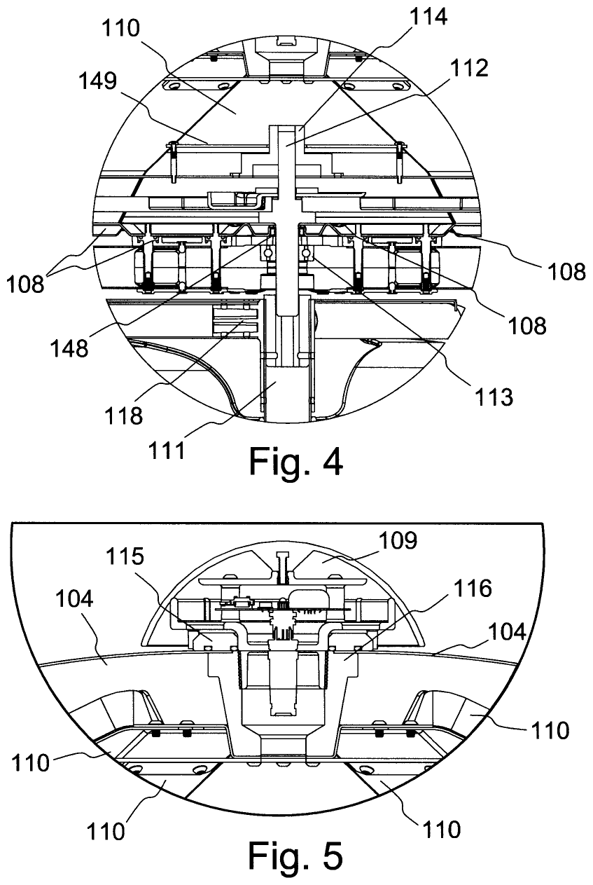

FIG. 4 is a detailed lateral sectional view taken at circular section 4-4 of FIG. 3. The view is taken through a drive shaft 112 where a drive underside interface 108 connects the dome drive to the rest of the structure. A magnetic brake 114 is used to stop wind milling during assembly or as required. Element 113 is the drive bearing. A power management PCB 149 communicates with the sensing and communications module in dome 109 through a waterproof connection port. A rotor connector 118 brings the (3) rotor blades together. A shaft seal 148 prevents water from penetrating this electrical chamber. A rotor drive shaft 111 turns a large fly wheel in both the top and bottom dome drive assemblies. Drive shaft 112 serves as a drive bearing connector that transfers lateral forces into the drive assembly. The underside of interface 108 shows elevation at leak points where water can penetrate the electronics.

FIG. 5 is a detailed lateral sectional view taken at semicircular section 5-5 of FIG. 3 and includes the sensing and communications module of dome 109. The dome 109 is a cover that is easily removed for sensing calibration and or communications replacement. Element 116 is the middle super structure load bearing interconnect. Element 110 is the middle dome super structure. Element 115 is an outer interconnect mounting ring.

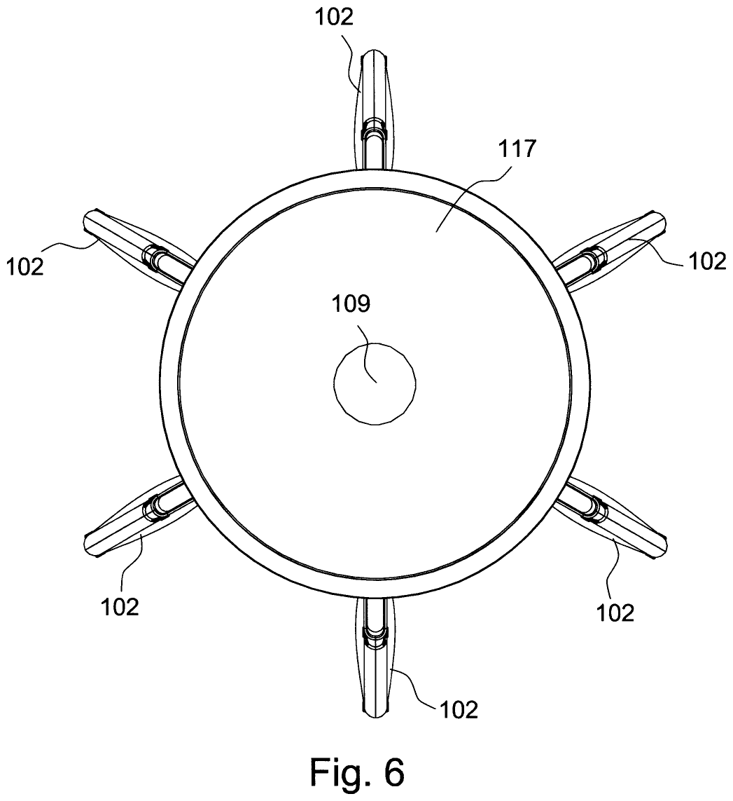

FIG. 6 is a plan view that describes how the upper dome 104 and the wings 102 forming the elliptical or egg-shaped profile of the wind turbine come together. The sensing module of the top of the dome 109 is where air samples flow over the top of the profile. The dome drive assembly 117 is positioned in with middle dome 104. The outer stater wing assembly 102 directs the wind towards the center of the turbine's profile.

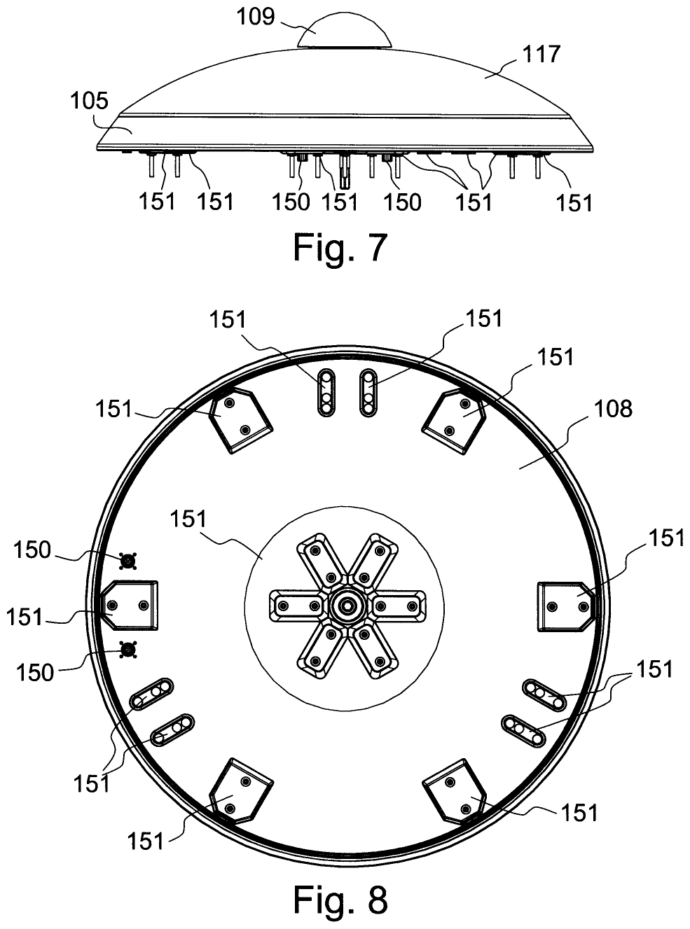

FIG. 7 is an elevation view of the dome drive assembly 117. Element 105 is the light bar. Element 109 is the top dome housing the sensing module.

Raised structural surfaces 151 keep water from penetrating the electrical housing. MC4 waterproof connectors 150 bring power from the lower dome assembly 104 to the upper dome assembly 104.

FIG. 8 is the underside of the dome assembly. Elements 151 are the raised surfaces which are used to shed water away from the mechanical interface. Elements 150 are further identified to be positive (+) and negative (−) DC power pickups that are used to bring power from the lower dome assembly 104 to the upper assembly 104.

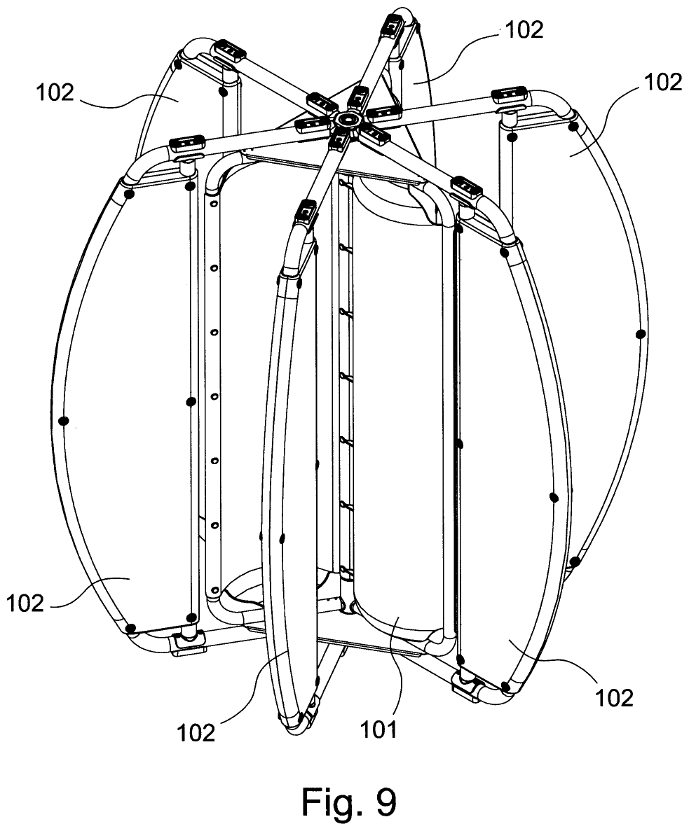

FIG. 9 is an isometric view of the middle section of the ellipse or egg shaped profile where tube shaped outer wings are assembled with the inner rotor assembly. Rotor 101 is an inner wing assembly while stator 102 is an outer structure. This shape lends itself to stretching a mesh around the upper portion of the array of wings, where the upper and lower portions are narrower than the middle section of the shape. The mesh resists displacement up or down when secured.

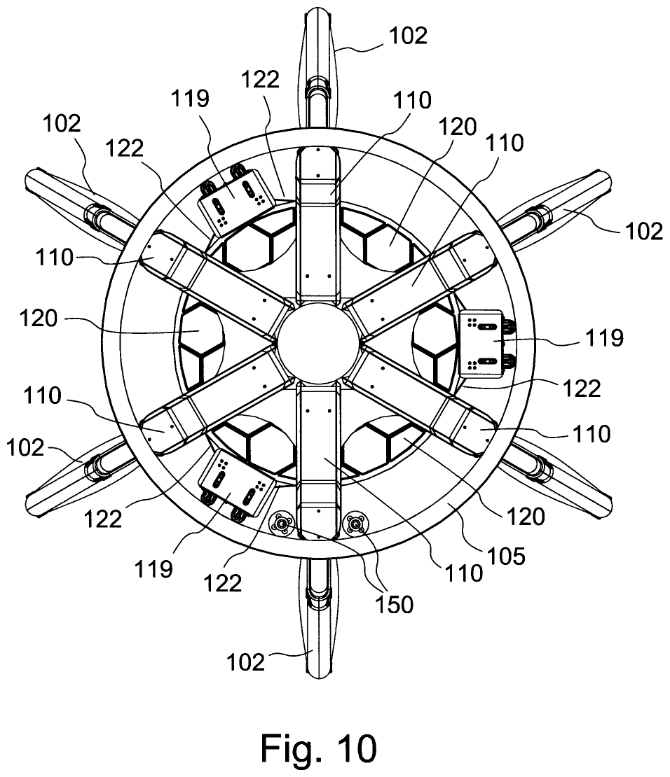

FIG. 10 is a plan view looking down on the assembly where the upper dome cover 104 is removed. This view reveals six generators within three covers 119. Element 105 is the light bar. The generators may be brushless generator/motors. Element 120 is a main 110:1 gear plate that spins a belt 122 that turns the brushless generators. Elements 110 are the middle dome super structures that come together to transfer loads through to the tubular outer wind shaping wings 102.

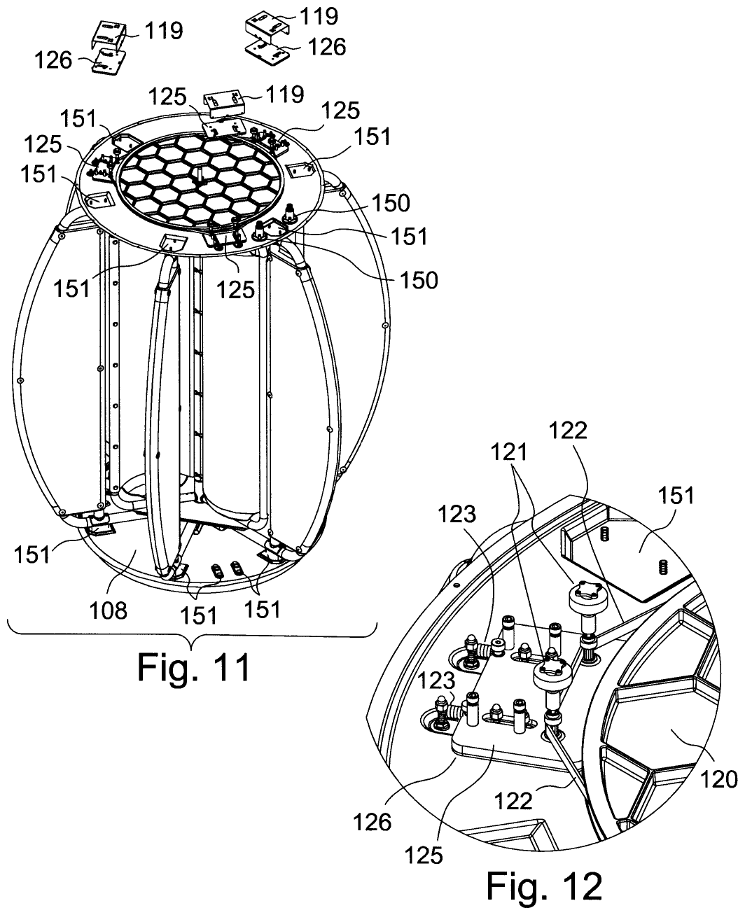

FIG. 11 is an isometric view of the turbine with the generator drive covers 119 in exploded view. Elements 126 are mounting plates for cover 119 and serve as slip plates. Elements 125 are carrier plates for the generators and are attached to the mounting plates 126, which mount on the raised structural surfaces 151. The three mounting plates 126 secure and tension the six small brushless generators. Each generator works independently. Element 108 is the lower drive underside interface.

FIG. 12 is an enlarged, detailed isometric view looking at the brushless generators/motors 121, which are operated as brushless generators. This view shows two (2) brushless generators 121 on a single carrier plate 1256, the large 100:1 gear plate 120, and the drive belt 122. Each cover 119 is applied to a lower mounting plate 126 that floats against spring pressure to tension of belt 122. Element 123 is a spring attached between an anchor rod and a floating plate 126 to pull the plate 126 against belt tension.

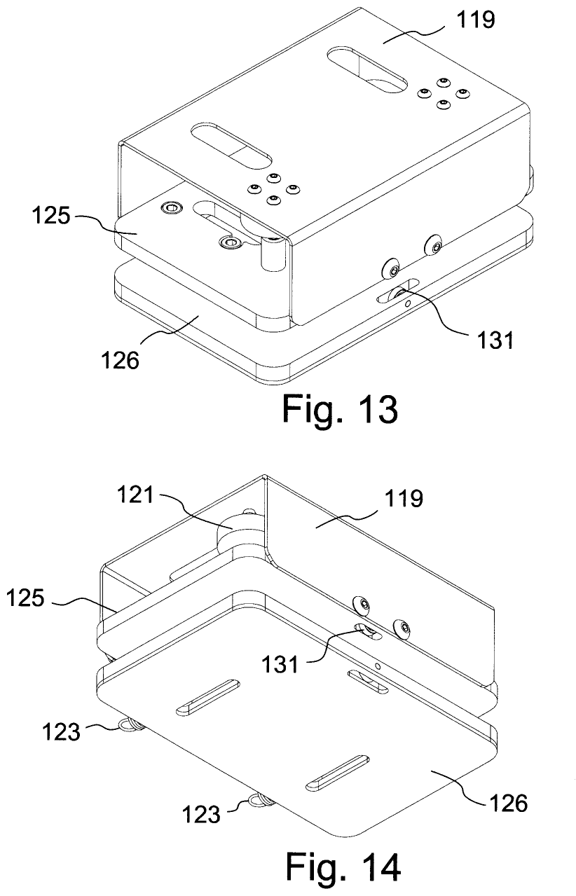

FIG. 13 is an isometric view of the dual drive generator assembly where 119 is a cover, 125 is a carrier for the generator drives, and 126 is a mounting plate for the carrier plate 125 and cover 119. Guide bearing 131 supports the generator drive assemblies against the spinning gear plate 120.

FIG. 14 is an underside isometric view of the dual drive generator assembly. Element 131 is the 100:1 gear plate guide bearing. Bearing 131 supports the gear plate 120 so that the belt runs true to the smaller gears 127, FIG. 16, driving generators 121. Springs 123 tension the floating plate 126 against the belt 122.

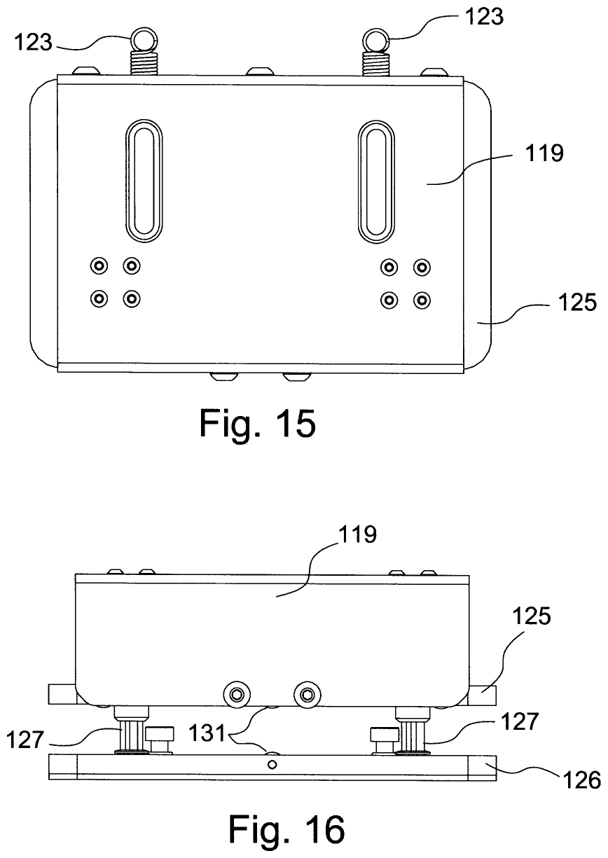

FIG. 15 is the top view of the dual generator drive assembly. Tension springs 123 hold a slight amount of tension on the belt 122, reducing friction, rather than a traditional belt tensioner that forces the belt in a serpentine path.

FIG. 16 is the dual generator drive assembly where detail 127 is a small gear that drives a generator. Slip plate 126 floats on the surface of the drive underside plate 108. Elements 131 are the (2×) gear plate guide bearings which prevent the gear plate 120 from wobble.

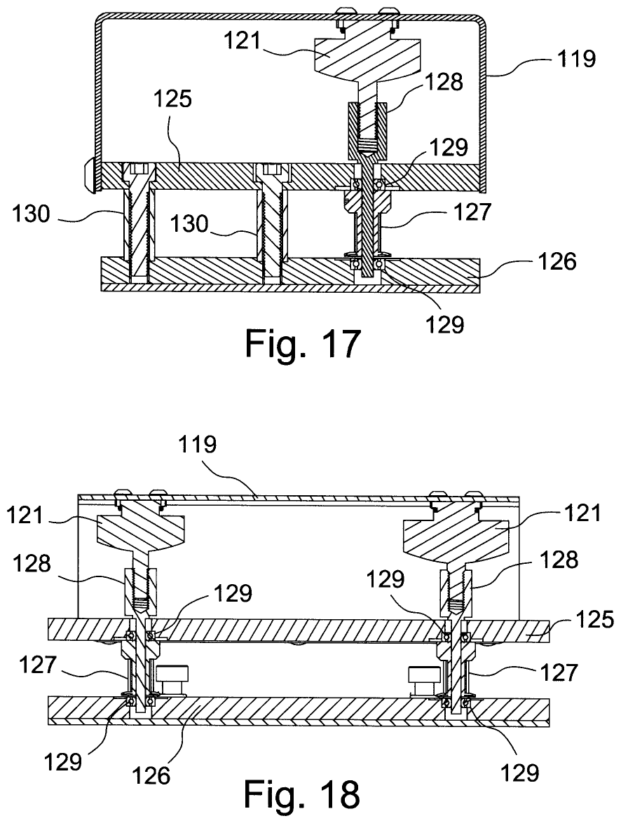

FIG. 17 is a lateral sectional view of the generator drive looking at (1×) generators 121, Generator bearings 129 are installed in carrier plates 125 and slip plate 126. Stand offs 130 support a gap between plates 125 and 126 and allow speed sprockets 127 to spin. Driveshaft 128 is keyed to spin the generator 121 using the large speed sprocket 120 and belt 122.

FIG. 18 is a sectional elevation view through both brushless generators 121 on a single carrier plate 125.

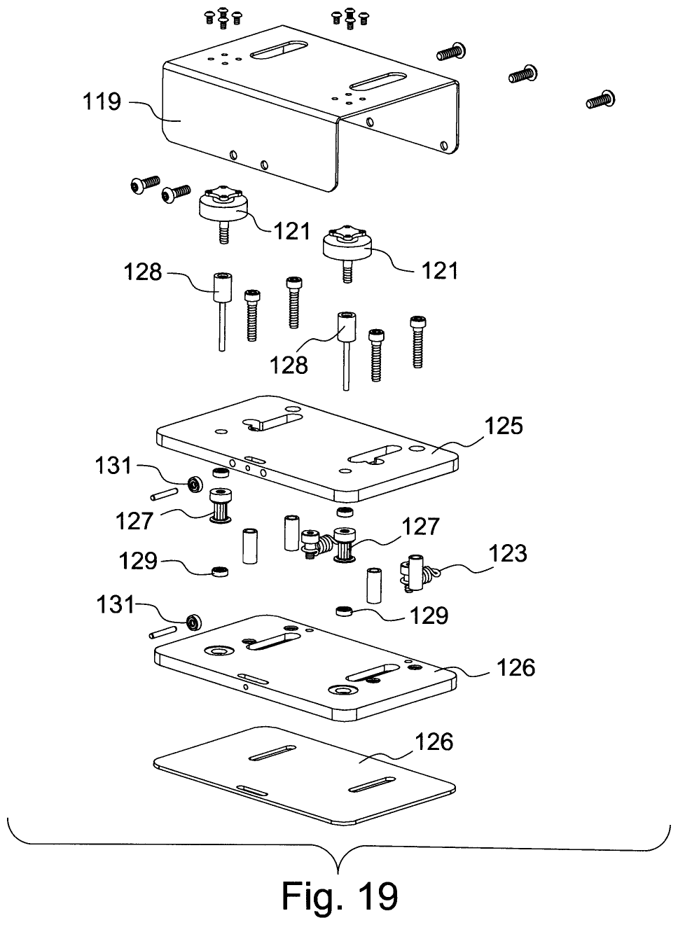

FIG. 19 is an exploded view showing the brushless dual generator drive assembly. The cover 119 serves as an upper mounting bracket that supports alignment of the generators from the top during usage. Springs 123 are shown in association with their anchor posts to a board 108. Driveshaft 128 both spins the generator 121 and supports its alignment from the bottom end, Gear plate guide bearing 131 stabilizes the gear plate 120. Safe bearing 129 supports the generator in slip plate 126 and in base plate 125, where the slip plate is mounted to board 108 to allow for lateral floating travel.

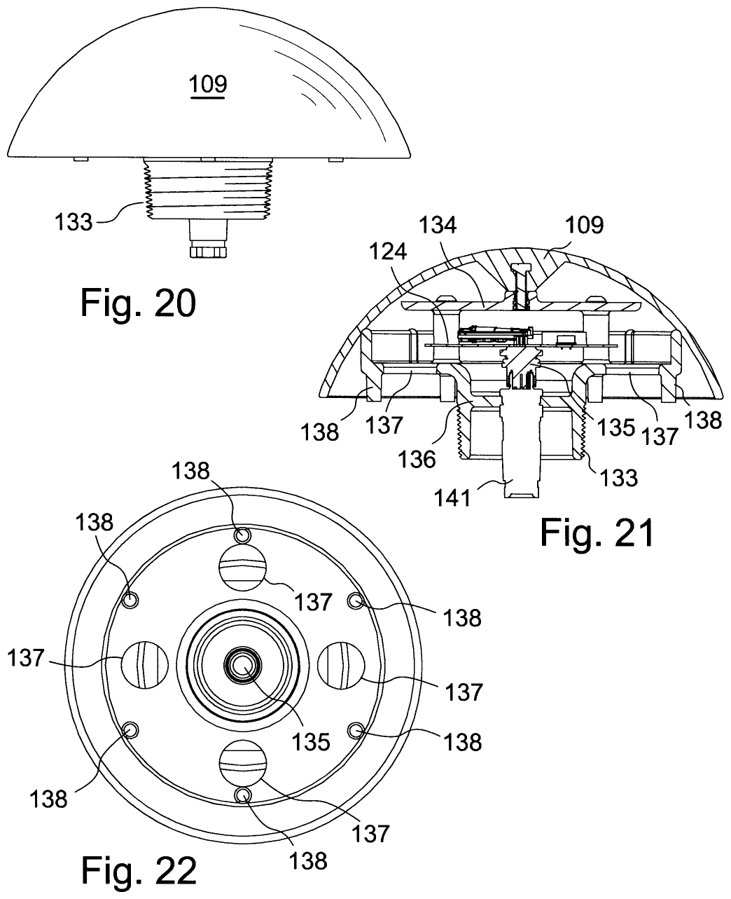

FIG. 20 is an elevation view of the sensing and communications subassembly of dome 109. Element 133 is a tapered pipe thread that screws into the middle structure load bearing interconnect 116 to provide sensing and communications to the internet when required. The tapered pipe thread 133 prevents water from penetrating the subassembly 109 and the lower assembly 116. The sensors measure CO2, NOX, temperature, and methane. A modem provides communication to a network. The sensing and communications subassembly 109 also controls the colors and color behavior based from an IoT database controlled by the end user of the light bar. The subassembly communicates and gets its power where the power is made and monitored.

FIG. 21 is a lateral sectional view of the sensing and communications subassembly. The dome 109 can be removed and installed with by screwing it down into mounting structure 134. Element 124 is the sensing and communications daughter board that has sensors that are exposed to ambient air that flows in and out of the structure. A sensing/communications super structure 136 connects all of the components together. A connector 135 serves to transmit the sensing/communications daughter board communications and sends and receives signals from the motherboard and transmits power and light to the power drive assembly of middle dome 104. A further connector 141 is waterproof and serves as an internal sensing connector.

FIG. 22 is the underside of the sensing and communications module. Element 137 is 1 of 4 a vent holes that allow for air samples to be taken. 138 is a stud that takes loads and transfers them to the dome when high wind speeds get up and under the assembly.

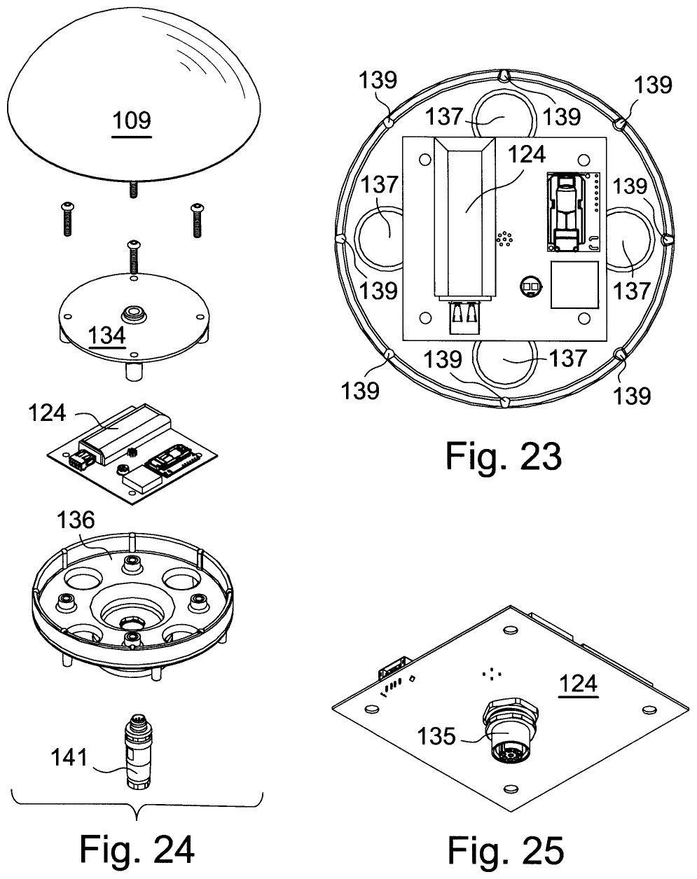

FIG. 23 is a plan view looking down on the sensing and communications module with the cover removed. Elements 137 are (4×) air quality sampling ports. Elements 139 are snap detente dimples 139 secure the lid from unscrewing during high vibration and wind speeds. Element 124 is the sampling and communications daughter board assembly. Element 124 is preferred to be a cellular model with Bluetooth and wifi on board with sensors that read air quality. Those measurements include; carbon monoxide (CO), oxides of nitrogen (NO₂ and NO₃), ozone (O₃), lead (Pb), particulate matter (PM). sulfur dioxide (SO₂), and volatile organic compounds (VOC).

FIG. 24 is an exploded view of the sensing and communications module. Lower connector 135 sends sensing signals and internet communications to the mother board inside the assembly. Dome cover 109 keeps water out of the electronics. Element 134 is a mounting structure. Element 124 is the sampling and communications board. The sensing/communications super structure 136 serves as a base structure for mounting daughter board 124. Waterproof connector 141 bridges communications and sensing to the motherboard.

FIG. 25 is the sensing and communications daughter board 124, which has a watertight connector 135 on the underside. This makes field replacement easy to plug and play. Connector 135 may be connected to connector 141.

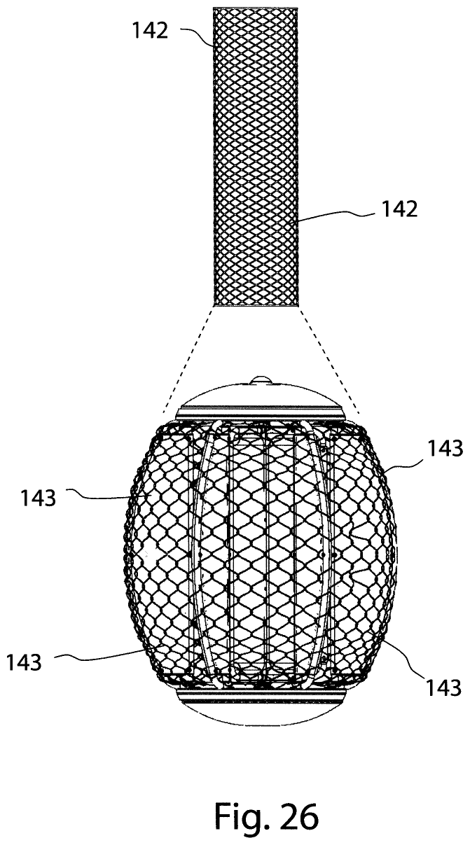

FIG. 26 is a side elevation view showing at a top portion a wildlife mesh body 142, and projects this mesh body to a lower portion showing how the mesh body is reconfigured at 143 to fit over an elliptical wind turbine. The wildlife mesh 142 is tubular with an open end at least at the bottom end in the view of FIG. 26. For convenience and economy of production, the tube has both top and bottom open ends open with respect to the vertical position shown at the top portion of FIG. 26. In the illustrated relaxed, uninstalled state and when considered in three dimensions, the mesh body 142 is a tubular shape. It may have an even width as viewed at the top portion of FIG. 26. That even width is narrower than the width of the wind turbine, again according to the view in FIG. 26. Dashed projection lines between top and bottom portions of FIG. 26 show an expansion of mesh, deforming the even tube as it expands during installation on the wind turbine by pulling an open end over an end of the wind turbine. For convenience and efficiency the mesh is applied over the top axial end of the turbine.

From the view of FIG. 26, the turbine is seen to have a vertical profile that is generally egg-shaped or an ellipse. A central, vertical axis extends between the ends. The description of the wind turbine may employ the term, “egg-shaped.” In some definitions this term can refer to shape with one broader end. There is no requirement that one or the opposite ends be broader. A preferred shape is elliptical in side profile as shown in FIG. 26, where an ellipse is defined as a rectangle with rounded corners. Thus, the resulting shape of the turbine may have equal but narrower widths at opposite axial ends and a broader center. Such an elliptical shape has advantages over an egg-shape by permitting many parts to be symmetrical, which can be an aid to fabrication and fitting parts such as wings 102. Thus, the he term, “elliptical,” may be used to describe the general shape of the wind turbine. The drawings show the wind turbine as being symmetrical at opposite ends, making either end a suitable starting end for application of the tubular wildlife mesh 142.

FIG. 26 further discloses a method of applying a wildlife mesh to a turbine when the central axis of the turbine is accessible from at least one end. This method is suitable for applying the mesh when the turbine is suitably accessible at an assembly plant or suitably accessible in a field installation. The installed wildlife mesh 143 is secured in position on the elliptical turbine first by pulling the tubular shape over the turbine by an open end, which may be the lower end in FIG. 26, resulting in the lower end stretching in width as it receives the top end of the turbine. The mesh stretches to match the width or circumference of the turbine as it is advanced axially down the turbine. The open end is stretched as necessary to pass over the maximum circumference of the turbine at a point between the opposite ends. The maximum width is at a vertical middle of the elliptical turbine. The mesh has an elastic or resilient quality such that the open ends will contract upon further pulling toward the opposite, lower end of the turbine, which has a smaller circumference than the middle. At the completion of installation, the mid-area of the mesh located between the open ends is stretched by a major amount, conforming to the larger circumference at the vertical center or maximum circumference of the turbine's shape. The top and bottom edges of the wildlife mesh are stretched to a lesser amount due to their resilience and their respective positions at relatively smaller circumferences of the turbine near its vertical top and bottom ends. The top and bottom edges of the wildlife mesh perform a locking function because these edges will resist further stretching as would be necessary to further vertically move the wildlife mesh with respect to the elliptical shape of the turbine. The force required to stretch the wildlife mesh is sufficiently greater than dislocating forces of nature such as wind, rain, and snow that might be encountered while the wind turbine is in use in an outdoors setting. The dislocating forces would be too small to dislodge the position of the installed wildlife mesh.

The mesh might be formed from a nonmetallic material such as a plastic or synthetic material arranged in a matrix of strands that are joined at contact or intersection points, forming a mesh with a pattern of open holes. A preferred material of construction is vinyl plastic. The pattern plus the material of formation account for known specifications for elasticity and resilience of the mesh. Consideration of these known specifications and knowing the dimensions of the wind turbine allow selection of a tubular mesh body sized to fit the turbine and grip the turbine after installation. Particularly a nonmetallic material may be susceptible to damage while in service. As non-limiting examples, bird strikes could be a hazard for mesh on wind turbines placed in elevated positions. Ground animals could damage the mesh with their claws or teeth. Sunlight can degrade some materials over time and therefore could be a hazard if the mesh is constructed from a susceptible material. When damage has occurred to the wildlife mesh, the old mesh can be replaced in the field by cutting or pulling off the damaged mesh and installing a new mesh by pulling it over the elliptical turbine, as previously described.

The locking fit of the wildlife mesh on the wind turbine benefits from narrower portions on both ends of a broader central portion, regardless of whether the narrower portions are equally narrow. Thus, even if the narrower top or bottom ends were unequal in width, such as by the turbine being egg-shaped with a broader base end, the locking function is supported.

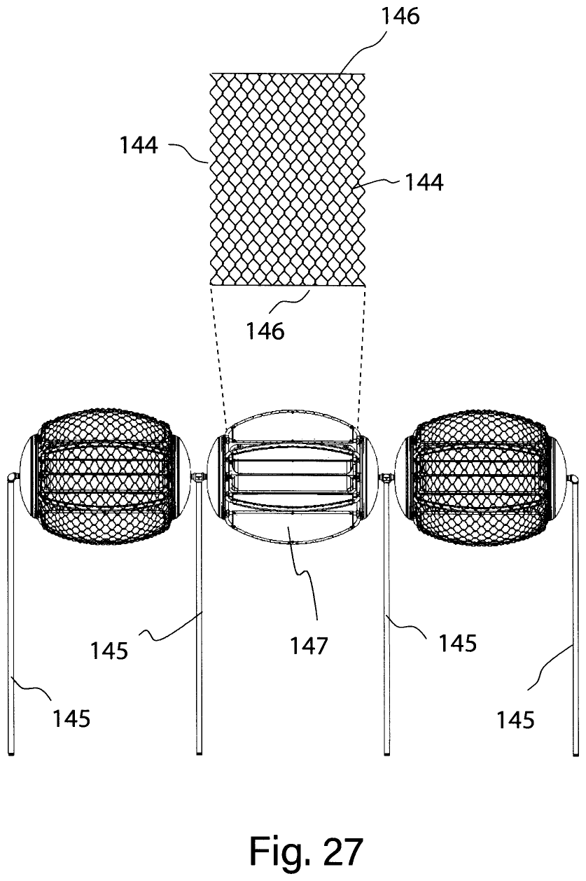

FIG. 27 is a side elevation view of the wildlife mesh as it can be used with stacked wind turbines. As shown in the top portion of FIG. 27, the mesh can be supplied as a flat single sheet 144. Elements 146 are termination edges that are brought together as the sheet of mesh is wrapped around the turbine to bring together the two opposite ends 146. The mesh can be wrapped around the wind turbine when it has been installed at the site in a stacked array, even when the stacking structures will not permit the tubular form of the mesh to be applied over an end of a turbine. The termination edges 146 may be curved so that at their meeting, the edges abut with the mesh drawn evenly around the turbine. If preferred, the curve may be configured to establish more or less tension in the mesh at the point when the edges 146 abut. For example, it may be preferred to establish more or less tension at the narrower ends or broader middle of the elliptical shape to prevent creep.

Another method of application employs a rectangular sheet of mesh. When wrapped around a turbine, excess length may be present at the narrower, opposite ends of the turbine. Any desired tension in the mesh sheet can be established by tying the termination edges inward of the termination edges. Excess mesh then can be trimmed to maintain an aerodynamic elliptical shape to the turbine.

The mesh can be wrapped around the turbine and secured even in the field after the turbine has been deployed in the field. The bottom portion of FIG. 27 shows a possible situation requiring field installation. Due to horizontal stacking of plural turbines in supporting framework 145, slipping a replacement tubular mesh over an end is not available, so the flat sheet mesh is employed. The field repair around the elliptical shape can be completed using the mesh sheet 144, which is projected by dashed lines to be applied to a bare turbine 147 in a stacked array, to be wrapped around the turbine, and seamed together at a meeting of the termination edges 146. The mesh shown at the upper portion of FIG. 27 is the mesh shape for this type of installation where a plurality of turbines is stacked, either vertically or horizontally.

Reference to seaming the sheet 144 are not limited to any particular techniques. In one definition, a seam can be a line of junction formed by sewing together two pieces of material along their margins. In another definition, a seam is a line, ridge, or groove made by fitting, joining, or lapping together two sections along their edges. Thus, in a broad way, seaming is the joining of two sections by any means.

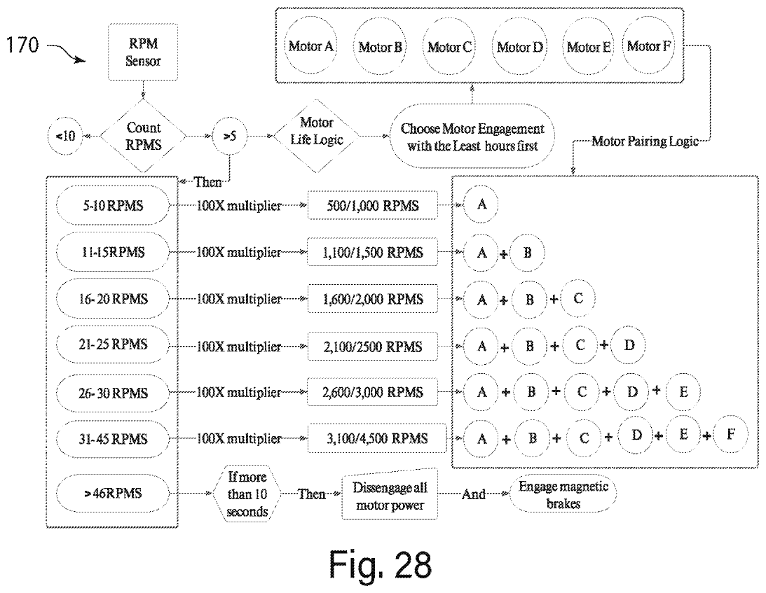

FIG. 28 shows a power management logic chart 170 that is optimized for low wind speeds. The logic works to balance the generator life by considering generator-on time. As the RPMs increase, other generators are included to load down the forces required to turn the rotor with back feed when the circuits are engaged. As the wind speeds increases, additional generators are engaged. This approach allows for power to begin being generated at low wind speeds. When the revolutions per minute reach the maximum generator rating, all generators are disengaged and magnetic brakes are engaged.

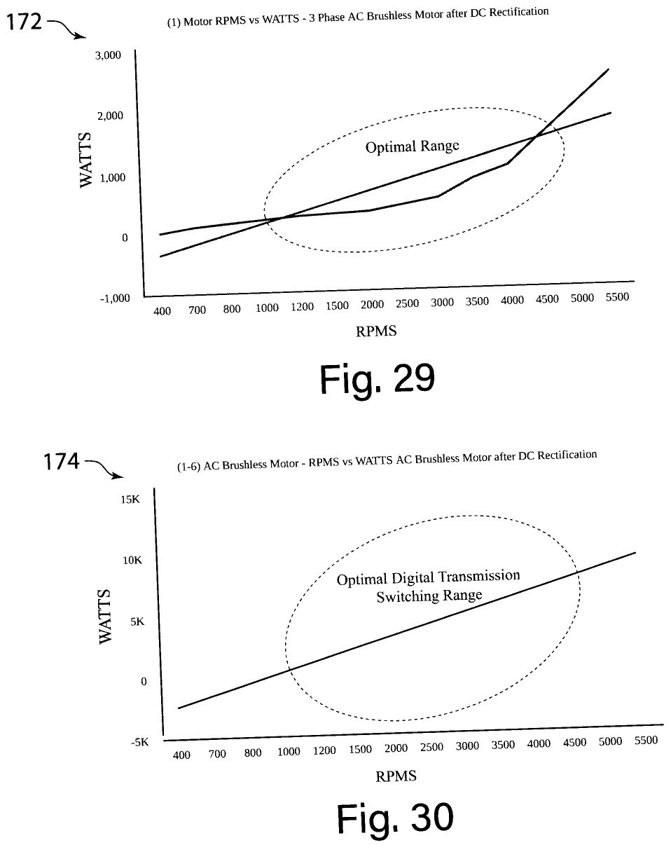

FIG. 29 shows a power graph 172 on a 3-Phase AC generator connected to a bridge rectifier. The AC motor/generator has low power when speeds are below 2000 RPMs. The logic will work to keep generators engaging with RPMs at the generator in the 1,200-4500 range to optimize the highest energy output using these high RPM generators.

FIG. 30 shows is a graph 174 of transmission switching range that engages 1-6 generators using a digital transmission. As the wind speed force increases, the logic engages generators to keep them from reaching critical speeds.

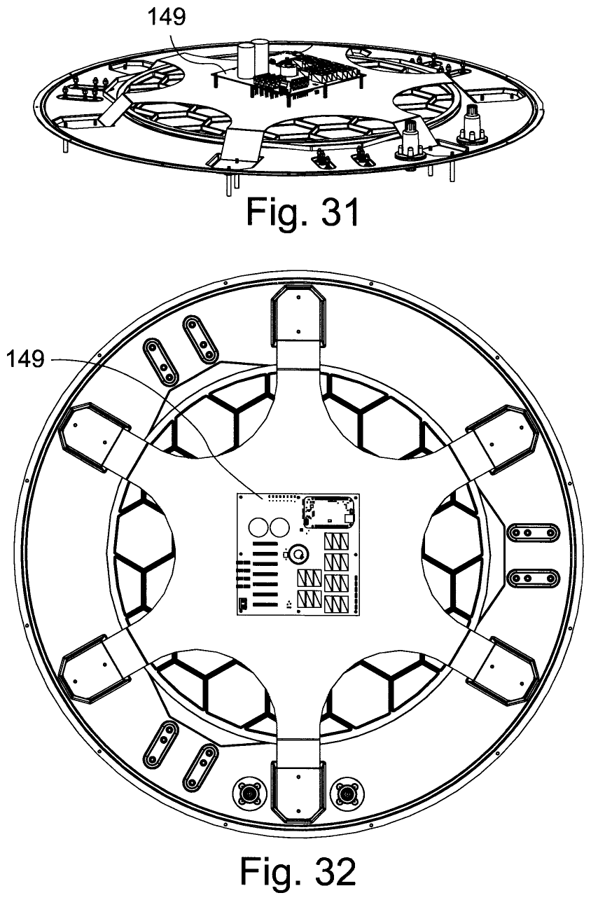

FIG. 31 is an isometric view of the power management PCB 149 shown without the dome and structure to identify the power management PCB. The power management PCB manages sending and generator power drive controls.

FIG. 32 is a plan view of the power management PCB 149 with the dome and structure removed to identify the assembly. The power management PCB brings all power together along with communications and sensing.

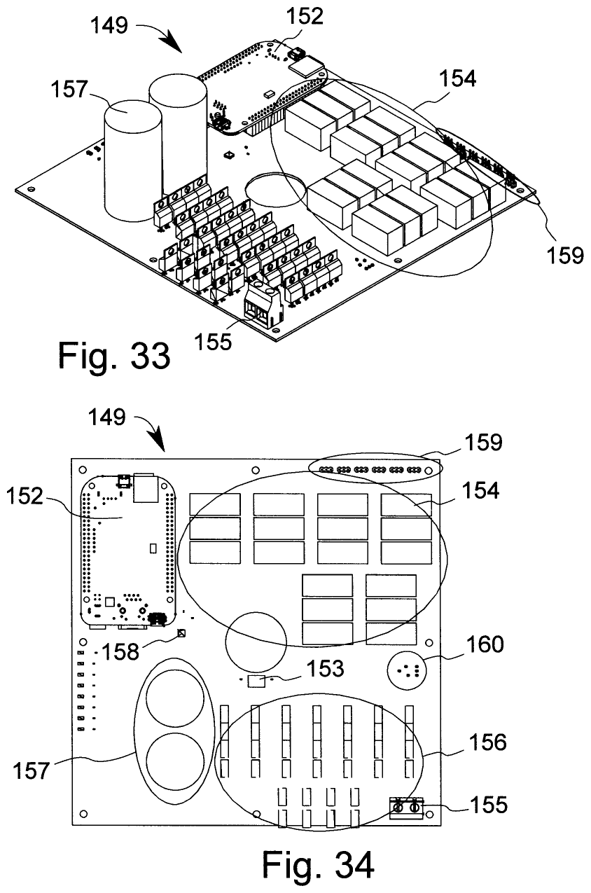

FIG. 33 is an isometric view of the power management PCB 149. A microprocessor 152 directs all operations of the wind turbine along with all radio communications. The microprocessor also communicates with the daughter-board 124, monitoring the environment: air quality, temperature, humidity. Depending on wind speed, the microprocessor switches an electronic transmission, which is an array 154 of multiple electronically-operated relays for switching to a low power/high power circuit. A pair of super capacitors 157 is dedicated to storing power and using that stored power in no-wind conditions. A 3-pole connectors 159 serve the generators' 3-phase input. An output connector 155 is available for connection to an industry-standard MC4 connector, common in solar applications.

FIG. 34 is a top view of the power management PCB 149. Diode arrays 156 and 160 rectify the 3-phase AC current produced by the generators into DC current. Array 160 is used specifically in low wind/low current applications where the forward voltage of bigger diodes is too big to overcome. A photo diode 153 measures the RPM of the rotor drive 111 and subsequently is operative to activate more generators, allowing for more power generation. An LED controller 158 operates the LED light bar 105 as appropriate, indicating maintenance, wind speed, return-on-investment, and wireless connectivity such as Bluetooth, WiFi 6, or Cellular 5G.

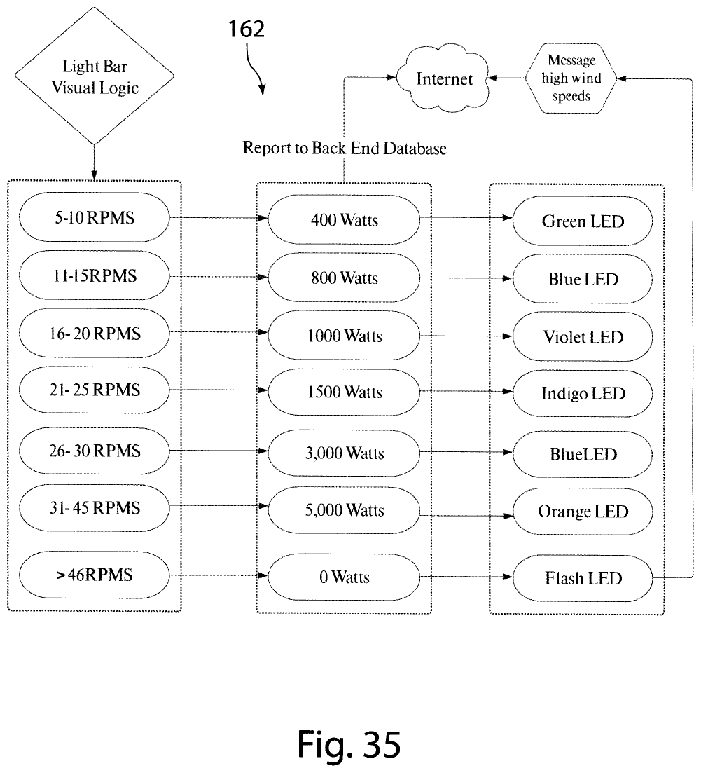

FIG. 35 is a diagram 162 that describes how the light bar 105 provides visual LED lights when various power is being generated. These lights can are displayed around the dome translucent light bar. These values are replicated on the internet in the customer's back end database. When the system goes into an overdrive condition, all generator generators are disengaged while the magnetic brakes are engaged.

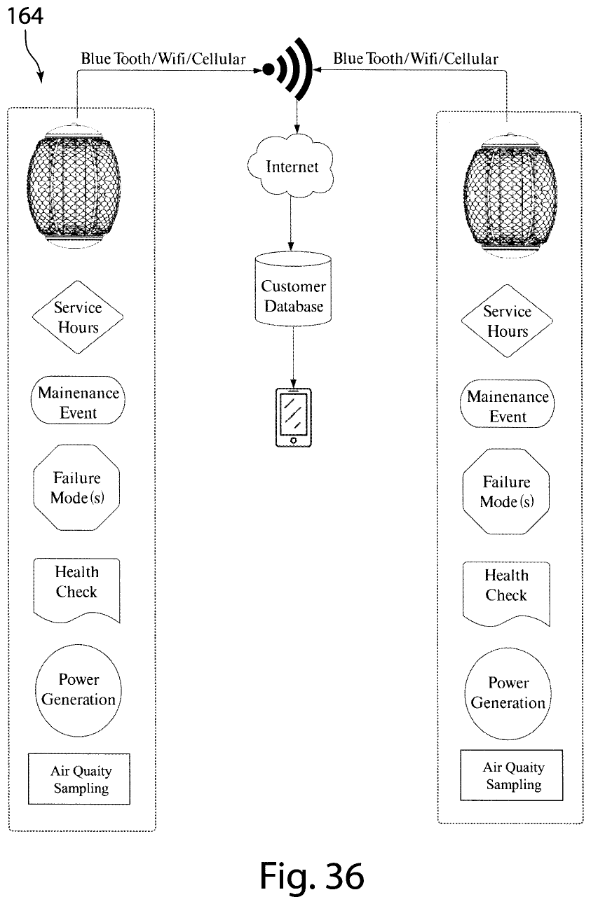

FIG. 36 is a communications diagram 164 showing communications date for a plurality of turbines. Data shows communicating service hours, maintenance events, failure modes and power generation to the customers back end database out on the internet. Each turbine is networked where one is the host and the others are clients. Sensors that read climate data are also included as data that is presented to the customer's mobile phone control software tool used to maintain and support the installation.

The shape of the turbine is that of an egg. The super structure made up of a thin wall, stainless steel turbine and sheet metal structure, lend themselves to a high strength multi functional shape that can withstand harsh weather conditions while making it easy to mount both horizontally and vertically. The shape has waterproofing features that divert water away from critical electronics, while taking ambient air quality measurements.

Onboard ambient air quality monitoring includes electronics that work with the waterproof structure. Air quality is measured and reported to a central database on air quality data for pollutants that include: carbon monoxide (CO), oxides of nitrogen (NO2 and NO3), ozone (O3), lead (Pb), particulate matter (PM), sulfur dioxide (SO2) and volatile organic compounds (VOC). The small dome 109 on top of the dome shape lends itself well to sampling air as it races past an overhanging shape that prevents water from damaging the electronics.

The wildlife mesh 142, 144 is repairable and replaceable. The elliptical or egg shape of the turbine lends itself well to securing a wildlife mesh in place. The mesh can slip over the top of the turbine while also being able to be replaced in the field when stacking configurations and mounting features prevent the tubular mesh from being installed, instead using a wrap around approach. The bulge in the center of the super structure is used to prevent the mesh from slipping off during high wind speeds.

According to traditional design, both vertical axis and horizontal wind turbines use a single generator to make power. When the electrical circuit is closed on the generator, excessive forces are needed to start making power are required. The elliptical or egg shaped turbine proposed uses large swings that increase wind forces on the rotor, which is tied to a large planetary gear. The large planetary gear has a belt that spins small brushless 3-Phase generators 121. The smaller generators collectively have enormous energy potential and have lower starting forces required to start making power. With the invention, an algorithm is used to control engagement of these small, brushless generators which require minimal force to overcome magnetic fields. When 6 or more coupled drone motor/generators work together, magnetic fields must be synchronized. This is accomplished by using marks on a fine tooth timing belt. For example, a G2 timing belt with a pitch length of 2.2 mm is suitable. A timing belt 119 may have 1000 teeth or more, allowing precise synchronization of the generators. When all of the generators are in mechanical sync, the starting forces to overcome the magnetic field are reduced, resulting in an optimized power generation solution.

By using a 100:1 gear ratio, the power curve is optimized for the drone motors/generators and pushes them to higher drone motor/generator speeds where power generation output is maximized. A digital transmission engages and disengages these drone motors/generators as wind speeds change. The small generators are paired up in sets of 2. An applied spring tension produces a consistent physical load on the belt so that teeth on the belt do not jump and create out-of-sync generator forces. The electronics that support engaging and disengaging the motors/generators are controlled by a microprocessor.

The 3-phase AC power that comes out of the brushless motors/generators must be rectified into DC power. The forward voltage starts low, resulting in two sizes of bridge rectifiers. Transmission logic moves around to each generator as the first generator to engage, resulting in an extended generator life. These small, high RPM brushless generators emerged from the drone industry, where while operated as motors they consume kilowatts of power when they turn at their highest revolutions per minute. When these motors/generators are used in clusters, special accommodation is required because they are not designed for heavy later loads. To remedy the problem, additional bearings are used to support the brushless generators/motors. A logic process determines when the last motor/generator in the cluster has been used to start the power generation. Then the logic process moves to engage the next motor/generator, which extends motor/generator life by using a FET as a low voltage triggered powered relay. This process creates power at low wind speeds where traditional generators cannot.

The wind turbine embodies a water proofing solution that provides structural rigidity while keeping water damage off of critical electronics. The underside of each generator drive assembly dome has a shape that moves water away from the drive shaft area and the rest of the mechanical bolts that connect the top and bottom of the egg shape.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

1. A wind turbine, comprising:
top and bottom ends at spaced positions on a central axis;
a central rotor formed of wind drivable air foils positioned between said top and bottom ends and carried for rotation along said central axis;
an outer array of wind-contactable, air-directing wings having an arcuate outside edge positioned between the top and bottom ends, wherein said wings have a transverse portion extending from said arcuate outside edge toward the central axis in position to direct airflow from the outside edge toward said central rotor to drive rotation of said air foils;
a top dome at the top end of the central axis and above a top end of the central rotor and wings;
a bottom dome at the bottom end of the central axis and below a bottom end of the central rotor and wings;
at least one of said top and bottom domes carrying a plurality of current generators having driving connection with the central rotor, a transmission operating to control members of said plurality of current generators, and a processor monitoring performance of the central rotor and in response thereto directing said operation of said transmission; and
the top and bottom domes plus the arcuate outside edges of the wings form a profile that relative to the top and bottom ends has a broader width at a middle portion and a narrower width at upper and lower portions, at least with respect to the array of wings.

2. The wind turbine of claim 1, wherein said profile is egg-shaped.

3. The wind turbine of claim 1, wherein said profile is elliptical.

4. The wind turbine of claim 1, wherein said top and bottom domes respectively define a top exterior dome surface and a bottom exterior dome surface wherein said dome surfaces follow the arcuate contour established by said outsides edges of said wings.

5. The wind turbine of claim 1, further comprising:
an external wildlife net;
wherein, relative to said top and bottom ends, said net wraps both said narrower width at said upper and lower portions of said array of wings and wraps said broader middle width portion thereof, the variation in width between the upper narrow width and the middle broader width, and between the lower bottom narrow width and the middle broader width, provides resistance to displacement of the net between the upper and lower ends of the array of wings.

6. The wind turbine of claim 5, wherein said wildlife net has tubular configuration and is expandable, wherein the degree of expansion is relatively less at said narrower ends of said array of wings and is relatively greater at said broader middle width of the array of wings; and
the wildlife net has an unexpanded width that is less than the said narrower width at either said upper or lower portion of the array of wings.

7. The wind turbine of claim 5, wherein said wildlife net is a single sheet and is in wrapped configuration around said array of wings to establish a meeting of opposite edges; and
further comprising a junction at said meeting of edges, wherein said junction establishes both a snug fit at said narrow ends of said array of wings and a snug fit at said broader middle of the array of wings.

8. The wind turbine of claim 1, further comprising:
a relatively larger diameter gear attached to said central rotor for rotation therewith;
a plurality of relatively smaller diameter gears attached to rotate each of said current generators;
a toothed timing belt in driven engagement with said larger diameter gear and in driving engagement with said smaller diameter gears;
wherein said generators each have a magnetic field and said timing belt is synchronized with the generators to overcome said magnetic fields and thereby produce reduced starting forces.

9. The wind turbine of claim 8, wherein:
wherein said is transmission is programmed to operate at generator startup to vary selection of a first generator to engage, thereby resulting in extended generator life.
